(19) United States
(12) Patent Application Publication
(10) Pub. No.: US 2025/0199660 A1
(43) Pub. Date: Jun. 19, 2025

(54) DATA INTERACTION METHOD, NON-TRANSITORY COMPUTER-READABLE MEDIUM, AND ELECTRONIC DEVICE

(71) Applicant: Beijing Volcano Engine Technology Co., Ltd., Beijing (CN)

(72) Inventors: Xiaokang WEN, Beijing (CN); Chenxi MA, Beijing (CN); Lu LI, Beijing (CN)

(21) Appl. No.: 18/981,020

(22) Filed: Dec. 13, 2024

(30) Foreign Application Priority Data
Dec. 14, 2023 (CN) 202311725200.9

(51) Int. Cl. G06F 3/0484; G06F 3/0483; G06F 3/14; G06F 16/2458

(52) U.S. Cl. CPC G06F 3/0484; G06F 3/0483; G06F 3/1446; G06F 16/2458; G06F 2203/04803

(57) ABSTRACT

The present disclosure relates to a data interaction method, a non-transitory computer-readable medium, and an electronic device, which can perform a data interaction operation on pushed data in an application, thereby improving data interaction efficiency. The method includes: displaying, on a display interface of a first application program, target data pushed by a data platform through a first display panel; and in response to a trigger operation on an interactive control in the first display panel, reducing the first display panel for display, and displaying, on the display interface of the first application program, a data interaction result based on the target data through a second display panel, where the second display panel is displayed side by side with or in parallel to the first display panel.

### CROSS-REFERENCE TO RELATED APPLICATION

The present application claims priority of the Chinese Patent Application No. 202311725200.9, filed on Dec. 14, 2023, the disclosure of which is incorporated herein by reference in its entirety as part of the present application.

### TECHNICAL FIELD

The present disclosure relates to the field of computer technologies, and in particular, to a data interaction method, a non-transitory computer-readable medium, and an electronic device

### BACKGROUND

With the development of communication technologies, an increasing number of data platforms provide data push services, for example, data is pushed to an application program that subscribes to a push service, so that data can be acquired in a timely manner, and data utilization efficiency is improved.

In the related art, data pushed by a data platform can be viewed in an application program. However, when data interaction operations such as analyzing and processing data are required, it is necessary to enter the data platform to perform the data interaction operations, which is cumbersome, has a long data interaction link, and has low interaction efficiency.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

The present disclosure provides a data interaction method, and the data interaction method comprises:
displaying target data pushed by a data platform through a first display panel on a display interface of a first application; and
in response to a trigger operation on an interactive control in the first display panel, reducing the first display panel for display, and displaying, on the display interface of the first application, a data interaction result based on the target data through a second display panel, where the second display panel is displayed side by side with or in parallel to the first display panel.

The present disclosure provides a data interaction apparatus, and the data interaction apparatus comprises: a first display module and a second display module.

The first display module is configured to display target data pushed by a data platform through a first display panel on a display interface of a first application.

The second display module is configured to in response to a trigger operation on an interactive control in the first display panel, reduce the first display panel for display, and display a data interaction result based on the target data through a second display panel on the display interface of the first application, where the second display panel is displayed side by side with or in parallel to the first display panel.

The present disclosure provides a computer-readable medium having a computer program stored thereon, where when the program is executed by a processing apparatus, the steps of the data interaction method are implemented.

The present disclosure provides an electronic device, where the electronic device comprises: a storage apparatus and a processing apparatus.

The storage apparatus has a computer program stored thereon.

The processing apparatus is configured to execute the computer program in the storage apparatus, to implement the steps of the data interaction method.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the drawings are schematic and that parts and elements are not necessarily drawn to scale. In the drawings:

FIG. 1 is a schematic flowchart of a data interaction method according to an exemplary embodiment;

FIG. 2 is a schematic diagram of an application interface according to an exemplary embodiment;

FIG. 3 is a schematic diagram of viewing details according to an exemplary embodiment;

FIG. 4 is a schematic diagram of viewing an SQL according to an exemplary embodiment;

FIG. 5 is a schematic diagram of a preset analysis instruction according to an exemplary embodiment;

FIG. 6 is a schematic diagram of switching a dataset according to an exemplary embodiment;

FIG. 7 is a schematic diagram of a feedback control according to an exemplary embodiment;

FIG. 8 is a schematic diagram of jumping to a data platform according to an exemplary embodiment;

FIG. 9 is a schematic diagram of switching a chart type according to an exemplary embodiment;

FIG. 10 is a block diagram of a data analysis apparatus according to an exemplary embodiment; and

FIG. 11 is a block diagram of an electronic device according to an exemplary embodiment.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this regard.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that the concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It may be understood that before the technical solutions disclosed in the embodiments of the present disclosure are used, the user is informed of the type, scope of use, usage scenario, and the like of the personal information involved in the present disclosure in an appropriate manner according to the relevant laws and regulations, and the user's authorization is obtained.

For example, when receiving an active request from a user, a prompt message is sent to the user to explicitly prompt the user that the operation requested by the user needs to acquire and use the user's personal information. Therefore, the user can choose whether to provide the personal information to software or hardware such as an electronic device, an application, a server, or a storage medium that performs the operation of the technical solution of the present disclosure according to the prompt message.

As an optional but non-limiting implementation, in response to receiving an active request from a user, the prompt message is sent to the user, for example, in a pop-up window, and the prompt message may be presented in text in the pop-up window. In addition, the pop-up window may also carry a selection control for the user to select “agree” or “disagree” to provide personal information to the electronic device.

It may be understood that the above notification and user authorization process is only illustrative, and does not limit the implementation of the present disclosure. Other methods that comply with relevant laws and regulations may also be applied to the implementation of the present disclosure.

It may be understood that the data involved in the technical solution of the present disclosure (including but not limited to the data itself, the acquisition or use of the data) shall comply with the requirements of corresponding laws, regulations and related regulations.

In the related art, data pushed by a data platform can be viewed in an application. However, when data interaction operations such as analyzing and processing data are required, it is necessary to enter the data platform to perform the data interaction operations, which is cumbersome, has a long data interaction link, and has low interaction efficiency.

In view of this, the present disclosure provides a data interaction method and apparatus, a readable medium, and an electronic device, to solve the above technical problems.

The following further explains the embodiments of the present disclosure with reference to the accompanying drawings.

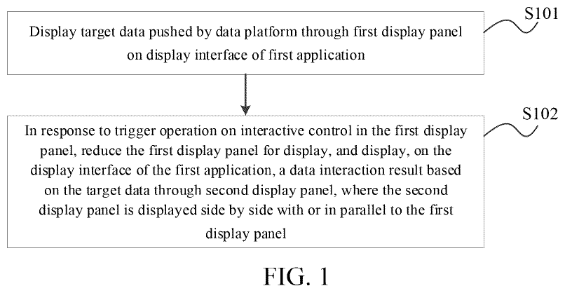

FIG. 1 is a flowchart of a data interaction method according to an exemplary embodiment of the present disclosure. Referring to FIG. 1, the method includes the following steps.

In S101, target data pushed by a data platform is displayed through a first display panel on a display interface of a first application.

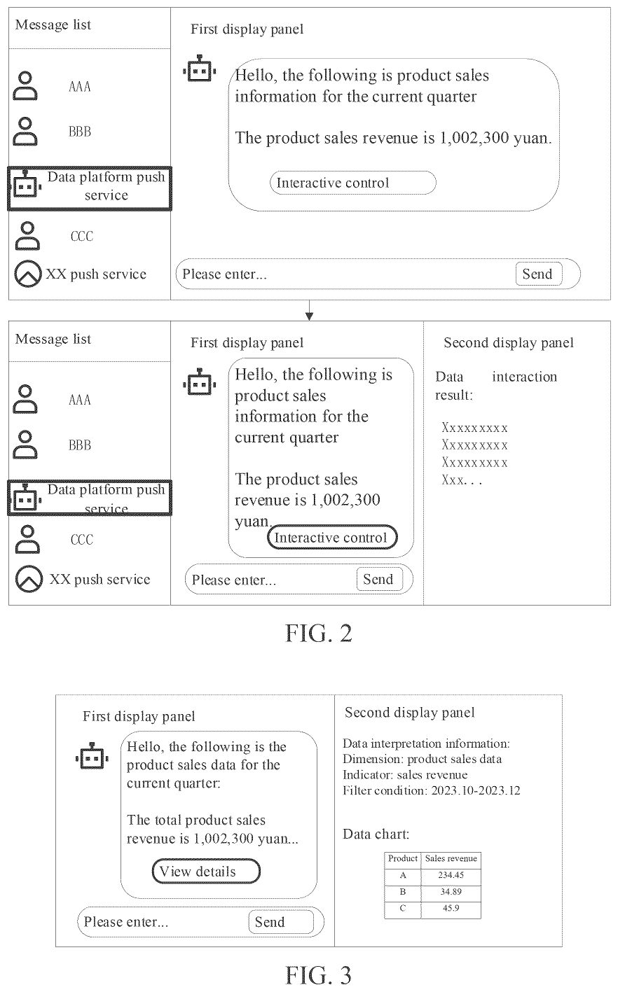

For example, the application may be an instant messaging (IM) application, or another application that can receive pushed data. This is not limited in the present disclosure. Referring to FIG. 2, taking an IM application as an example, a display interface of an IM application usually includes a message list. By triggering any account in the message list, a chat interface of the account may be displayed on a first display panel. As shown in FIG. 2, the pushed data pushed by a data platform and corresponding to the account is displayed.

It should be understood that the pushed data may be the pushed data actively pushed by the data platform, or may be the pushed data sent in response to a data request operation of the application, which is not limited in the present disclosure.

In S102, in response to a trigger operation on an interactive control in the first display panel, the first display panel is reduced for display, and a data interaction result based on the target data is displayed on the display interface of the first application through a second display panel, where the second display panel is displayed side by side with or in parallel to the first display panel.

For example, referring to FIG. 2, by triggering an interactive control in the first display panel, the first display panel may be reduced for display, and a data interaction result based on the target data is displayed on the second display panel. The second display panel is displayed side by side with or in parallel to the first display panel, which is not limited in the present disclosure. FIG. 2 shows an effect of the second display panel being displayed side by side with the first display panel.

It should be noted that a display manner of the first display panel and the second display panel in the application may be designed according to different electronic devices or requirements, which is not limited in the present disclosure. For example, an interface of an application at a computer end may be the interface shown in FIG. 2, while an application at a mobile phone end may be configured to first display a message list, switch to display the first display panel from the message list after a data platform push service in the message list is triggered, and then switch to display the second display panel after the interactive control is triggered, and so on, which is not limited in the present disclosure.

With the above method, target data pushed by a data platform is displayed through a first display panel on a display interface of a first application, and in response to a trigger operation on an interactive control in the first display panel, the first display panel is reduced for display, and a data interaction result based on the target data is displayed on the display interface of the first application through a second display panel. In this way, not only the pushed data can be viewed in the application, but also a data interaction operation can be performed on the pushed data in the application without entering the data platform, thereby simplifying the data interaction process, facilitating the operation, and improving the data interaction efficiency.

In a possible manner, the in response to a trigger operation on an interactive control in the first display panel, reducing the first display panel for display, and displaying, on the display interface of the first application, a data interaction result based on the target data through a second display panel may include: in response to a trigger operation on a first view control in the first display panel, displaying, on the display interface of the first application, data details corresponding to the target data through the second display panel, where the data details comprise data interpretation information of the target data and/or a data chart generated based on the target data; and/or in response to a trigger operation on a second view control in the first display panel, displaying, on the display interface of the first application, a structured query language (SQL) statement for querying the target data through the second display panel.

For example, referring to FIG. 3, the interactive control in the first display panel may be the first view control for viewing the data details, and the data details corresponding to the target data are displayed on the second display panel in response to the “View details” control being triggered. Taking the target data as product sales data for the current quarter as an example, the first display panel displays total product sales revenue for the current quarter, and the second display panel displays at least one of data interpretation information of the total product sales revenue for the current quarter and a data chart generated based on the total product sales revenue for the current quarter, where the data interpretation information may be information such as data dimensions, data indicators, and filter conditions, and the data chart may be sales revenue for each product corresponding to the total product sales revenue for the current quarter. The data chart may be specifically set according to an actual business scenario and requirements. For example, the data chart may also be sales revenue in each region, and so on, which is not limited in the present disclosure.

Therefore, data details of the pushed data can be viewed in the application without entering the data platform, thereby simplifying the data viewing process, facilitating the operation, and improving the efficiency of viewing the data details.

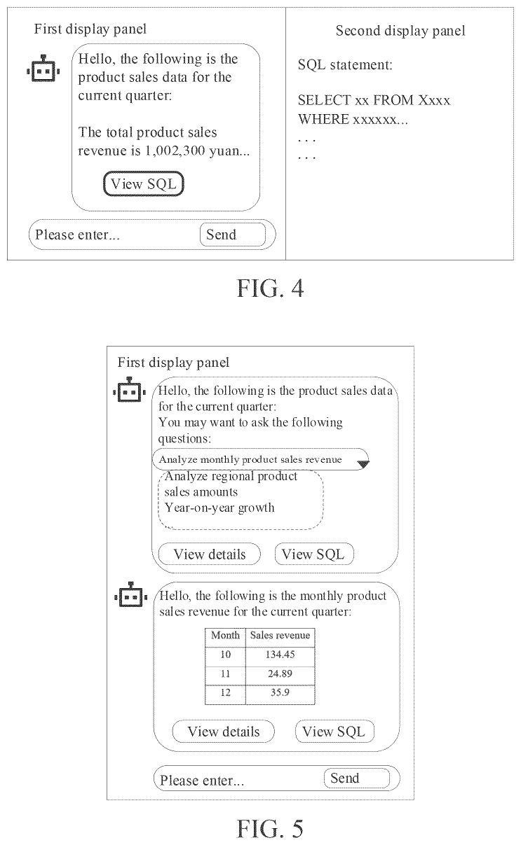

For example, referring to FIG. 4, the interactive control in the first display panel may be the first view control for querying the SQL statement of the target data, and the SQL statement for querying the target data is displayed on the second display panel in response to the “View SQL” control being triggered. Taking the target data as product sales data in the current quarter as an example, the first display panel displays total product sales revenue for the current quarter, and the second display panel displays the SQL statement for querying the total product sales revenue for the current quarter. Therefore, the SQL statement for querying the pushed data can be viewed in the application without entering the data platform, thereby improving the efficiency of viewing the SQL statement of the pushed data.

In a possible manner, the data interaction method further comprises: displaying a preset analysis instruction for the target data in the first display panel; and in response to a selection operation on a target analysis instruction in the preset analysis instruction, displaying, in the first display panel, a data analysis result obtained by analyzing the target data according to the target analysis instruction.

For example, referring to FIG. 5, a preset analysis instruction for the target data is displayed in the first display panel, for example, analyzing monthly product sales revenue and the like. The preset analysis instruction is specifically set according to an actual business scenario, which is not limited in the present disclosure. The preset analysis instruction may be displayed in a drop-down box, or may be displayed in an instruction list, and so on, which is not limited in the present disclosure. For example, when “analyze monthly product sales revenue” is selected, product sales revenue for each month is displayed in the first display panel. Therefore, data analysis can be performed on the pushed data in the application, which is easy to operate and improves the efficiency of data analysis.

For example, in addition to displaying the preset analysis instruction, an analysis instruction may also be entered through an input box, that is, the data analysis is performed on the target data in a chat manner. In addition, the prompt information such as data dimensions and data indicators may also be displayed, so that the analysis instruction can be entered based on the prompt information, and so on. This is not limited in the present disclosure.

In a possible manner, the data interaction method further comprises: displaying a switching control for switching a dataset to which displayed data belongs in the first display panel; in response to a trigger operation on the switching control, displaying selectable candidate datasets in the first display panel; and in response to a selection operation on a target dataset in the candidate datasets, displaying, in the first display panel, data in the target dataset.

For example, referring to FIG. 6, a switching control for switching a dataset to which displayed data belongs is displayed in the first display panel. In response to a trigger operation on the switching control, selectable candidate datasets are displayed in the first display panel. The candidate datasets may be displayed in a drop-down box, or may be displayed in a dataset list, and so on. This is not limited in the present disclosure. As shown in FIG. 6, the data currently displayed is data of dataset 1, and when dataset 2 is selected, data of dataset 2 is displayed, for example, switching from a product sales dataset to a product production dataset. Then, operations such as viewing and analyzing on data in dataset 2 can be performed. Therefore, operations such as viewing and analyzing on other datasets can be switched in the application, which is easy to operate and improves the efficiency of data operations.

In a possible manner, the data interaction method further comprises: displaying a result feedback control for the data interaction result while the data interaction result is displayed, where the result feedback control comprises a first feedback control for representing positive feedback and/or a second feedback control for representing negative feedback; in response to a trigger operation on the first feedback control, using a positive feedback result corresponding to the first feedback control as a feedback result for the data interaction result, where the feedback result for the data interaction result is used by the data platform for function optimization; and in response to a trigger operation on the second feedback control, using a negative feedback result corresponding to the second feedback control as a feedback result for the data interaction result.

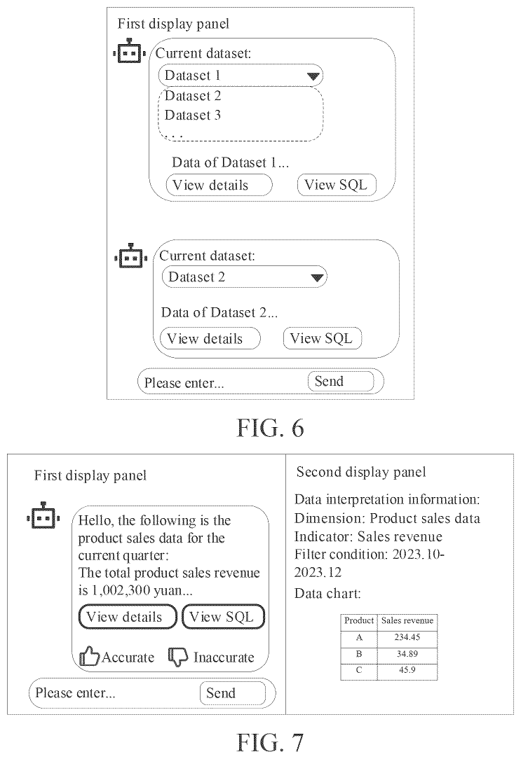

For example, a result feedback control for the data interaction result is displayed while the data interaction result is displayed, for example, at least one of “accurate” representing positive feedback and “inaccurate” representing negative feedback as shown in FIG. 7. The feedback result of the data interaction result may be determined according to a trigger operation on the result feedback control. The positive feedback represents that the data has high accuracy and can be used by the data platform for function optimization. The negative feedback represents that the data has low accuracy, and the data corresponding to the negative feedback may not be considered when the data platform performs function optimization, or may be used as a negative sample when the function optimization requires positive and negative samples. This is not limited in the present disclosure. Therefore, the function of the data platform can be continuously optimized based on the feedback result of the data interaction result.

In addition, the negative feedback control may be displayed but the positive feedback control may not be displayed. When the negative feedback control is not triggered, it is considered that the feedback result of the data interaction result is positive feedback, or the positive feedback control may be displayed but the negative feedback control may not be displayed, and so on. This is not limited in the present disclosure.

It should be understood that the feedback control may be displayed in the first display panel or the second display panel, and may be specifically set according to requirements, which is not limited in the present disclosure.

In a possible manner, the second display panel displays a sub-interactive control for performing an interactive function on the data interaction result, and the data interaction method further comprises: in response to a trigger operation on the sub-interactive control in the second display panel, jumping to the data platform, and displaying a function tab related to the interactive function corresponding to the sub-interactive control in the data platform; and/or in response to a trigger operation on the sub-interactive control in the second display panel, displaying a sub-interaction result in the second display panel, where the sub-interaction result is obtained by performing the interactive function corresponding to the sub-interactive control.

For example, an interactive operation may be performed on the data interaction result in the second display panel, for example, jumping to a function tab related to the interactive function corresponding to the sub-interactive control in the data platform, displaying a sub-interaction result in the second display panel, and so on. This is not limited in the present disclosure. Therefore, the data interaction operation may be continuously performed on the data interaction result in the application, which is easy to operate and improves the data interaction efficiency.

In a possible manner, the in response to a trigger operation on the sub-interactive control in the second display panel, jumping to the data platform, and displaying a function tab related to the interactive function corresponding to the sub-interactive control in the data platform may include: in response to a trigger operation on a first sub-interactive control in the second display panel, jumping to the data platform, and displaying a dataset tab in the data platform, where the first sub-interactive control is used to view a dataset associated with the data interaction result; and/or in response to a trigger operation on a second sub-interactive control in the second display panel, jumping to the data platform, and displaying an SQL tab in the data platform, where the second sub-interactive control is used to view an SQL statement for generating the data interaction result.

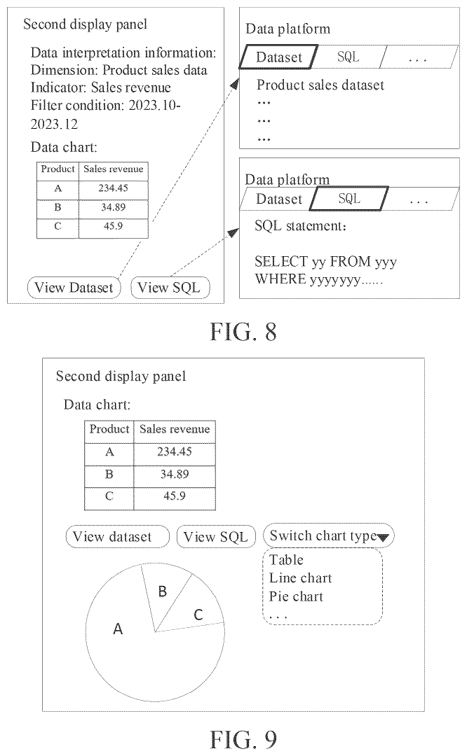

For example, referring to FIG. 8, the second display panel displays at least one of a “View dataset” control for viewing a dataset associated with the data interaction result and a “View SQL” control for viewing an SQL statement for generating the data interaction result. In response to a trigger operation on the “View dataset” control, a dataset tab of the data platform may be jumped to, and the dataset associated with the data interaction result is displayed. In addition, in response to a trigger operation on the “View SQL” control in the second display panel, an SQL tab of the data platform may be jumped to, and the SQL statement for generating the data interaction result is displayed. In this way, an interactive operation can be performed between the application and the data platform, thereby improving the application collaboration capability and the data processing capability.

It should be understood that, by triggering the “View SQL” control in the first display panel, the SQL tab of the data platform may also be jumped to, and the SQL statement for querying the target data is displayed. This may be specifically set according to requirements. This is not limited in the present disclosure.

In a possible manner, the data interaction result comprises a data chart generated based on the target data, and the in response to a trigger operation on the sub-interactive control in the second display panel, displaying a sub-interaction result in the second display panel may include: in response to a trigger operation on a target third sub-interactive control in the second display panel, switching, in the second display panel, a chart type of the data chart according to a chart type corresponding to the target third sub-interactive control, where the second display panel displays a plurality of third sub-interactive controls that are different, each of the plurality of third sub-interactive controls is used to indicate one data chart type, and the target third sub-interactive control is one of the plurality of third sub-interactive controls.

For example, referring to FIG. 9, the second display panel displays third sub-interactive controls corresponding to different data chart types. The plurality of third sub-interactive controls may be displayed in a control list, or may be displayed in a drop-down box, and so on. This is not limited in the present disclosure. The chart type of the data chart is switched according to the chart type corresponding to the target third sub-interactive control. For example, when a pie chart is selected for switching, the data chart in a table type is switched to the data chart in a pie chart type in the second display panel. Therefore, the chart type of the data chart can be switched, thereby improving the flexibility of data display.

It should be noted that when the target data in the first display panel is displayed in a data chart, a control for switching the data chart type may also be displayed to switch the chart type of the data chart in the first display panel. This is not limited in the present disclosure.

It should be understood that in the application interfaces shown in FIG. 2 to FIG. 9, the interface styles, layouts, menu names, control names, displayed data, data charts, and the like are only used as examples and do not constitute a limitation to the solution. The specific content may be determined according to an actual business scenario and requirements. This is not limited in the present disclosure.

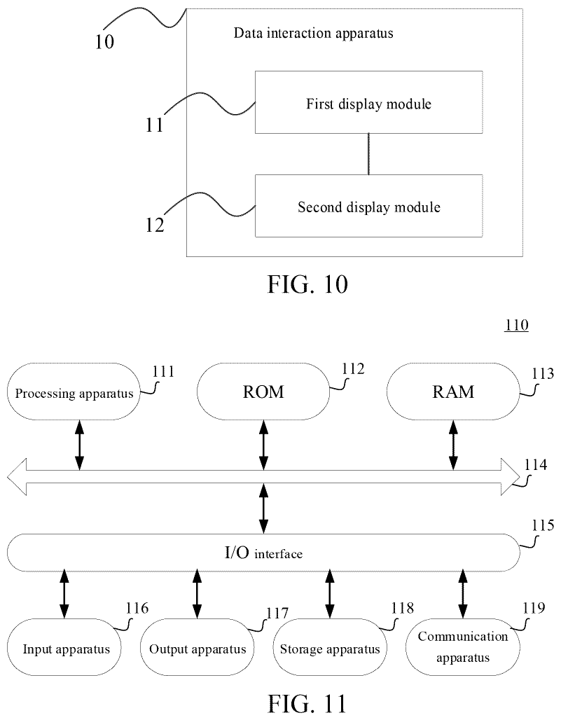

Based on the same inventive concept, the present disclosure further provides a data interaction apparatus. Referring to FIG. 10, the data interaction apparatus 10 includes: a first display module 11 and a second display module 12.

The first display module 11 is configured to display target data pushed by a data platform through a first display panel on a display interface of a first application.

The second display module 12 is configured to in response to a trigger operation on an interactive control in the first display panel, reduce the first display panel for display, and display a data interaction result based on the target data through a second display panel on the display interface of the first application, where the second display panel is displayed side by side with or in parallel to the first display panel.

With the above apparatus, not only the pushed data can be viewed in the application, but also a data interaction operation can be performed on the pushed data in the application without entering the data platform, thereby simplifying the data interaction process, facilitating the operation, and improving the data interaction efficiency.

Optionally, the second display module 12 is configured to:
in response to a trigger operation on a first view control in the first display panel, display data details corresponding to the target data through the second display panel on the display interface of the first application, where the data details comprise data interpretation information of the target data and/or a data chart generated based on the target data; and/or
in response to a trigger operation on a second view control in the first display panel, display a structured query language (SQL) statement for querying the target data through the second display panel on the display interface of the first application.

Optionally, the data interaction apparatus 10 further comprises an analysis module, and the analysis module is configured to:
display a preset analysis instruction for the target data in the first display panel; and
in response to a selection operation on a target analysis instruction in the preset analysis instruction, display, in the first display panel, a data analysis result obtained by analyzing the target data according to the target analysis instruction.

Optionally, the data interaction apparatus 10 further comprises a dataset switching module, and the dataset switching module is configured to:
display a switching control for switching a dataset to which displayed data belongs in the first display panel;
in response to a trigger operation on the switching control, display selectable candidate datasets in the first display panel; and
in response to a selection operation on a target dataset in the candidate datasets, display, in the first display panel, data in the target dataset.

Optionally, the data interaction apparatus 10 further comprises a feedback module, and the feedback module is configured to:
display a result feedback control for the data interaction result while the data interaction result is displayed, where the result feedback control comprises a first feedback control for representing positive feedback and/or a second feedback control for representing negative feedback;
in response to a trigger operation on the first feedback control, use a positive feedback result corresponding to the first feedback control as a feedback result for the data interaction result, where the feedback result for the data interaction result is used by the data platform for function optimization; and
in response to a trigger operation on the second feedback control, use a negative feedback result corresponding to the second feedback control as a feedback result for the data interaction result.

Optionally, the second display panel displays a sub-interactive control for performing an interactive function on the data interaction result, and the data interaction apparatus 10 further comprises: a first interaction module and a second interaction module.

The first interaction module is configured to in response to a trigger operation on the sub-interactive control in the second display panel, jump to the data platform, and display a function tab related to the interactive function corresponding to the sub-interactive control in the data platform; and/or
the second interaction module is configured to in response to a trigger operation on the sub-interactive control in the second display panel, display a sub-interaction result in the second display panel, where the sub-interaction result is obtained by performing the interactive function corresponding to the sub-interactive control.

Optionally, the first interaction module is configured to:
in response to a trigger operation on a first sub-interactive control in the second display panel, jump to the data platform, and display a dataset tab in the data platform, where the first sub-interactive control is used to view a dataset associated with the data interaction result; and/or
in response to a trigger operation on a second sub-interactive control in the second display panel, jump to the data platform, and display an SQL tab in the data platform, where the second sub-interactive control is used to view an SQL statement for generating the data interaction result.

Optionally, the second interaction module is configured to:
in response to a trigger operation on a target third sub-interactive control in the second display panel, switch, in the second display panel, a chart type of the data chart according to a chart type corresponding to the target third sub-interactive control, where the second display panel displays a plurality of third sub-interactive controls that are different, each of the plurality of third sub-interactive controls is used to indicate one data chart type, and the target third sub-interactive control is one of the plurality of third sub-interactive controls.

For the apparatus in the above embodiments, the specific manner in which each module performs an operation has been described in detail in the embodiments related to the method, and will not be described in detail herein.

Based on the same concept, an embodiment of the present disclosure further provides a computer-readable medium having a computer program stored thereon, when the program is executed by a processing apparatus, the steps of the above data interaction method are implemented.

Based on the same concept, an embodiment of the present disclosure further provides an electronic device, which includes a storage apparatus and a processing apparatus.

The storage apparatus has a computer program stored thereon.

The processing apparatus is configured to execute the computer program in the storage apparatus, to implement the steps of the above data interaction method.

Reference is made to FIG. 11 below, which shows a schematic diagram of a structure of an electronic device 110 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 11 is merely an example, and shall not impose any limitation on the function and scope of use of the embodiments of the present disclosure.

As shown in FIG. 11, the electronic device 110 may include a processing apparatus (for example, a central processing unit, a graphics processing unit, etc.) 111 that may perform a variety of appropriate actions and processing in accordance with a program stored in a read-only memory (ROM) 112 or a program loaded from a storage apparatus 118 into a random access memory (RAM) 113. The RAM 113 further stores various programs and data required for the operation of the electronic device 110. The processing apparatus 111, the ROM 112, and the RAM 113 are connected to each other through a bus 114. An input/output (I/O) interface 115 is also connected to the bus 114.

Generally, the following apparatuses may be connected to the I/O interface 115: an input apparatus 116 including, for example, a touch screen, a touchpad, a keyboard, a mouse, a camera, a microphone, an accelerometer, and a gyroscope; an output apparatus 117 including, for example, a liquid crystal display (LCD), a speaker, and a vibrator; a storage apparatus 118 including, for example, a tape and a hard disk; and a communication apparatus 119. The communication apparatus 119 may allow the electronic device 110 to perform wireless or wired communication with other devices to exchange data. Although FIG. 11 shows the electronic device 110 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 119 and installed, installed from the storage apparatus 118, or installed from the ROM 112. When the computer program is executed by the processing apparatus 111, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, communication may be performed using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: display target data pushed by a data platform through a first display panel on a display interface of a first application; and in response to a trigger operation on an interactive control in the first display panel, reduce the first display panel for display, and display a data interaction result based on the target data through a second display panel on the display interface of the first application, where the second display panel is displayed side by side with or in parallel to the first display panel.

Computer program code for performing the operations in the present disclosure may be written in one or more programming languages or a combination thereof, where the programming languages include but are not limited to an object-oriented programming language such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user over any kind of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession may actually be executed substantially in parallel, or they may sometimes be executed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments described in the present disclosure may be implemented by means of software, or may be implemented by means of hardware. The name of a module does not constitute a limitation on the module in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The above descriptions are merely preferred embodiments of the present disclosure and explanations of the applied technical principles. Those skilled in the art should understand that the scope of disclosure involved in the present disclosure is not limited to the technical solutions formed by specific combinations of the above technical features, and should also cover other technical solutions formed by any combination of the above technical features or their equivalent features without departing from the above disclosure concept. For example, the above technical solutions formed by replacing the above features with technical features with similar functions disclosed in the present disclosure (but not limited thereto).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. On the contrary, various features described in the context of a single embodiment can also be implemented in multiple embodiments individually or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely exemplary forms of implementing the claims. For the apparatus in the above embodiments, the specific manner in which each module performs an operation has been described in detail in the embodiments related to the method, and will not be described in detail herein.

1. A data interaction method, comprising:
displaying target data pushed by a data platform through a first display panel on a display interface of a first application; and
in response to a trigger operation on an interactive control in the first display panel, reducing the first display panel for display, and displaying, on the display interface of the first application, a data interaction result based on the target data through a second display panel, wherein the second display panel is displayed side by side with or in parallel to the first display panel.

2. The data interaction method according to claim 1, wherein the in response to a trigger operation on an interactive control in the first display panel, reducing the first display panel for display, and displaying, on the display interface of the first application, a data interaction result based on the target data through a second display panel, comprises:
in response to a trigger operation on a first view control in the first display panel, displaying, on the display interface of the first application, data details corresponding to the target data through the second display panel, wherein the data details comprise data interpretation information of the target data and/or a data chart generated based on the target data; and/or
in response to a trigger operation on a second view control in the first display panel, displaying, on the display interface of the first application, a structured query language (SQL) statement for querying the target data through the second display panel.

3. The data interaction method according to claim 1, further comprising:
displaying a preset analysis instruction for the target data in the first display panel; and
in response to a selection operation on a target analysis instruction in the preset analysis instruction, displaying, in the first display panel, a data analysis result obtained by analyzing the target data according to the target analysis instruction.

4. The data interaction method according to claim 1, further comprising:
displaying a switching control for switching a dataset to which displayed data belongs in the first display panel;
in response to a trigger operation on the switching control, displaying selectable candidate datasets in the first display panel; and
in response to a selection operation on a target dataset in the candidate datasets, displaying, in the first display panel, data in the target dataset.

5. The data interaction method according to claim 1, further comprising:
displaying a result feedback control for the data interaction result while the data interaction result is displayed, wherein the result feedback control comprises a first feedback control for representing positive feedback and/or a second feedback control for representing negative feedback;
in response to a trigger operation on the first feedback control, using a positive feedback result corresponding to the first feedback control as a feedback result for the data interaction result, wherein the feedback result for the data interaction result is used by the data platform for function optimization; and
in response to a trigger operation on the second feedback control, using a negative feedback result corresponding to the second feedback control as a feedback result for the data interaction result.

6. The data interaction method according to claim 1, wherein the second display panel displays a sub-interactive control for performing an interactive function on the data interaction result, and the data interaction method further comprises:
in response to a trigger operation on the sub-interactive control in the second display panel, jumping to the data platform, and displaying a function tab related to the interactive function corresponding to the sub-interactive control in the data platform; and/or
in response to a trigger operation on the sub-interactive control in the second display panel, displaying a sub-interaction result in the second display panel, wherein the sub-interaction result is obtained by performing the interactive function corresponding to the sub-interactive control.

7. The data interaction method according to claim 6, wherein the in response to a trigger operation on the sub-interactive control in the second display panel, jumping to the data platform, and displaying a function tab related to the interactive function corresponding to the sub-interactive control in the data platform comprises:
in response to a trigger operation on a first sub-interactive control in the second display panel, jumping to the data platform, and displaying a dataset tab in the data platform, wherein the first sub-interactive control is used to view a dataset associated with the data interaction result; and/or
in response to a trigger operation on a second sub-interactive control in the second display panel, jumping to the data platform, and displaying an SQL tab in the data platform, wherein the second sub-interactive control is used to view an SQL statement for generating the data interaction result.

8. The data interaction method according to claim 6, wherein the data interaction result comprises a data chart generated based on the target data, and the in response to a trigger operation on the sub-interactive control in the second display panel, displaying a sub-interaction result in the second display panel comprises:
in response to a trigger operation on a target third sub-interactive control in the second display panel, switching, in the second display panel, a chart type of the data chart according to a chart type corresponding to the target third sub-interactive control, wherein the second display panel displays a plurality of third sub-interactive controls that are different, each of the plurality of third sub-interactive controls is used to indicate one data chart type, and the target third sub-interactive control is one of the plurality of third sub-interactive controls.

9. A non-transitory computer-readable medium having a computer program stored thereon, wherein when the computer program is executed by a processing apparatus, causes the processing apparatus to implement a data interaction method, and the data interaction method comprises:
displaying target data pushed by a data platform through a first display panel on a display interface of a first application; and
in response to a trigger operation on an interactive control in the first display panel, reducing the first display panel for display, and displaying, on the display interface of the first application, a data interaction result based on the target data through a second display panel, wherein the second display panel is displayed side by side with or in parallel to the first display panel.

10. The non-transitory computer-readable medium according to claim 9, wherein the in response to a trigger operation on an interactive control in the first display panel, reducing the first display panel for display, and displaying, on the display interface of the first application, a data interaction result based on the target data through a second display panel, comprises:
in response to a trigger operation on a first view control in the first display panel, displaying, on the display interface of the first application, data details corresponding to the target data through the second display panel, wherein the data details comprise data interpretation information of the target data and/or a data chart generated based on the target data; and/or
in response to a trigger operation on a second view control in the first display panel, displaying, on the display interface of the first application, a structured query language (SQL) statement for querying the target data through the second display panel.

11. The non-transitory computer-readable medium according to claim 9, wherein the data interaction method further comprises:
displaying a preset analysis instruction for the target data in the first display panel; and
in response to a selection operation on a target analysis instruction in the preset analysis instruction, displaying, in the first display panel, a data analysis result obtained by analyzing the target data according to the target analysis instruction.

12. The non-transitory computer-readable medium according to claim 9, wherein the data interaction method further comprises:
displaying a switching control for switching a dataset to which displayed data belongs in the first display panel;
in response to a trigger operation on the switching control, displaying selectable candidate datasets in the first display panel; and
in response to a selection operation on a target dataset in the candidate datasets, displaying, in the first display panel, data in the target dataset.

13. The non-transitory computer-readable medium according to claim 9, wherein the data interaction method further comprises:
displaying a result feedback control for the data interaction result while the data interaction result is displayed, wherein the result feedback control comprises a first feedback control for representing positive feedback and/or a second feedback control for representing negative feedback;
in response to a trigger operation on the first feedback control, using a positive feedback result corresponding to the first feedback control as a feedback result for the data interaction result, wherein the feedback result for the data interaction result is used by the data platform for function optimization; and
in response to a trigger operation on the second feedback control, using a negative feedback result corresponding to the second feedback control as a feedback result for the data interaction result.

14. The non-transitory computer-readable medium according to claim 9, wherein the second display panel displays a sub-interactive control for performing an interactive function on the data interaction result, and the data interaction method further comprises:
in response to a trigger operation on the sub-interactive control in the second display panel, jumping to the data platform, and displaying a function tab related to the interactive function corresponding to the sub-interactive control in the data platform; and/or
in response to a trigger operation on the sub-interactive control in the second display panel, displaying a sub-interaction result in the second display panel, wherein the sub-interaction result is obtained by performing the interactive function corresponding to the sub-interactive control.

15. The data interaction method according to claim 14, wherein the in response to a trigger operation on the sub-interactive control in the second display panel, jumping to the data platform, and displaying a function tab related to the interactive function corresponding to the sub-interactive control in the data platform comprises:
in response to a trigger operation on a first sub-interactive control in the second display panel, jumping to the data platform, and displaying a dataset tab in the data platform, wherein the first sub-interactive control is used to view a dataset associated with the data interaction result; and/or
in response to a trigger operation on a second sub-interactive control in the second display panel, jumping to the data platform, and displaying an SQL tab in the data platform, wherein the second sub-interactive control is used to view an SQL statement for generating the data interaction result.

16. An electronic device, comprising:
a storage apparatus, having a computer program stored thereon; and
a processing apparatus, configured to execute the computer program in the storage apparatus, to implement a data interaction method, and the data interaction method comprises:
displaying target data pushed by a data platform through a first display panel on a display interface of a first application; and
in response to a trigger operation on an interactive control in the first display panel, reducing the first display panel for display, and displaying, on the display interface of the first application, a data interaction result based on the target data through a second display panel, wherein the second display panel is displayed side by side with or in parallel to the first display panel.

17. The electronic device according to claim 16, wherein the in response to a trigger operation on an interactive control in the first display panel, reducing the first display panel for display, and displaying, on the display interface of the first application, a data interaction result based on the target data through a second display panel, comprises:
in response to a trigger operation on a first view control in the first display panel, displaying, on the display interface of the first application, data details corresponding to the target data through the second display panel, wherein the data details comprise data interpretation information of the target data and/or a data chart generated based on the target data; and/or
in response to a trigger operation on a second view control in the first display panel, displaying, on the display interface of the first application, a structured query language (SQL) statement for querying the target data through the second display panel.

18. The electronic device according to claim 16, wherein the data interaction method further comprises:
displaying a preset analysis instruction for the target data in the first display panel; and
in response to a selection operation on a target analysis instruction in the preset analysis instruction, displaying, in the first display panel, a data analysis result obtained by analyzing the target data according to the target analysis instruction.

19. The electronic device according to claim 16, wherein the data interaction method further comprises:
displaying a switching control for switching a dataset to which displayed data belongs in the first display panel;
in response to a trigger operation on the switching control, displaying selectable candidate datasets in the first display panel; and
in response to a selection operation on a target dataset in the candidate datasets, displaying, in the first display panel, data in the target dataset.

20. The electronic device according to claim 16, wherein the data interaction method further comprises:
displaying a result feedback control for the data interaction result while the data interaction result is displayed, wherein the result feedback control comprises a first feedback control for representing positive feedback and/or a second feedback control for representing negative feedback;
in response to a trigger operation on the first feedback control, using a positive feedback result corresponding to the first feedback control as a feedback result for the data interaction result, wherein the feedback result for the data interaction result is used by the data platform for function optimization; and
in response to a trigger operation on the second feedback control, using a negative feedback result corresponding to the second feedback control as a feedback result for the data interaction result.
